(19) United States
(12) Patent Application Publication
(10) Pub. No.: US 2008/0191835 A1
(43) Pub. Date: Aug. 14, 2008

(54) Anti-Condensate Resistance With Ptc Thermistor and Process for Assembling Such Resistance

(76) Inventor: Roberto Brioschi, Borgoticino (IT)

Correspondence Address: SHELDON MAK ROSE & ANDERSON PC, 100 Corson Street, Third Floor, PASADENA, CA, 91103-3842, US

(21) Appl. No.: 11/572,315

(22) PCT Filed: Jul. 22, 2005
(86) PCT No.: PCT/IT05/00430

§ 371 Date: Jan. 18, 2007

(30) Foreign Application Priority Data
Jul. 27, 2004 (IT) TO2004A000523

(51) Int. Cl. H01C 1/024

(52) U.S. Cl. 338/237

(57) ABSTRACT

An anti-condensate resistance (1) with PTC thermistor 5 is disclosed, comprising a central heat sink element (3), such central heat sink element (3) being composed of two dissipating plates (3a, 3b) which are mutually facing and continuously joined in such a way as to form, in a space interposed between the plates, an inserting housing (15) of the PTC thermistor 5 together with a securing element (11), a first and a second closing plugs (7a, 7b) for closing openings of the inserting housing (15) and for hermetically sealing the PTC thermistor 5 inside the inserting housing (15); the dissipating plates (3a, 3b) being equipped with a convex curvature towards their center, each one of the dissipating plates (3a, 3b) being equipped at their ends with inserting tracks (4a, 4b) forming working portions (6a, 6b) on which forces (F) are exerted which are adapted to permanently set joining hourglasses (4c) of the dissipating plates (3a, 3b) for cancelling or reverting the curvature and blocking the PTC thermistor 5 in the inserting housing (15) and the closing plugs (7a, 7b) in the openings, and each one of the dissipating plates (3a, 3b) being equipped on an external surface with a plurality of dissipating wings (13); a process for assembling such anti-condensate resistance (1) is further described.

The present invention refers to an anti-condensate resistance with Positive Temperature Coefficient (PTC) thermistor; the present invention also refers to a process for assembling such resistance.

The use of PTC thermistors for realising anti-condensate resistances is known.

PTC thermistors are devices made of conductive or semiconductive materials that have a varying resistance depending on temperature; consequently, PTC thermistors have the advantageous chance of self-regulating themselves depending on temperatures and in this way they are not subjected to overheating, even in case an adequate heat removal is prevented (for example, profile clogging, accidental heat sink coverage with any object, etc.). In particular, anti-condensate resistances using PTC thermistors are, in the majority of cases, composed of an heat sink made in a single aluminium profile inside which the PTC thermistor is arranged and segregated through closing plugs; however, the technical disadvantages of such arrangement are numerous. First of all, the realisation of the heat sink in a single extrusion prevents the black anodisation of its internal surfaces and therefore heat is for a good part transmitted through conduction instead of radiance; under these conditions, therefore the heat sink must be unavoidably manufactured with a certain minimum thickness in order to guarantee a good conduction level.

Moreover, crimping of the heat sink generally occurs through profile bending, this imposing a minimum height of the heat sink that is much greater than the height of the PTC thermistor, with consequent negative effects in terms of encumbrance and manufacturing costs.

It is also known that in existing embodiments, PTC thermistors are kept in position inside the heat sink through more or less complex mechanical arrangements, such as screws, bolts or springs, this obviously increasing their complexity and manufacturing costs. Such internal locking systems must further allow the thermal expansion of the heating element keeping an adequate contact load, which is as much as possible constant.

Such known anti-condensate resistances with PTC thermistors moreover exist also in a forced-ventilation version through an external fan; such fan however, in order to be able to be simply supplied directly through an electric network connection, is generally at 230 V, thereby resulting relatively costly, encumbrant and oversized with respect to the power level to be dissipated.

Moreover, typically known and used closing plugs of a heat sink guarantee generally mediocre tightness levels.

The currently-used securing systems for anti-condensate resistances with PTC thermistors are normally made of metallic material, typically aluminium, to be able to resist to thermal stresses; moreover, they are composed of many pieces: typically a carrier structure and various mobile and/or elastic parts (for example springs) that allow its elastic mechanical locking.

Therefore, object of the present invention is solving the above prior art problems by providing an anti-condensate resistance with PTC thermistor which, depending on modularity of elements composing it, allows to be configured in a productively very simple way with different types of heat sink.

A further object of the present invention is providing an anti-condensate resistance with PTC thermistor equipped with a heat sink realised by assembling many extruded profiles, this allowing both an internal and an external anodisation in black or another colour, with consequent increase of heat transmission by radiance, decrease and related saving of materials to be used to make such profiles.

A further object of the present invention is providing an anti-condensate resistance with PTC thermistor inside whose heat sink the PTC thermistor is operatively secured without the need of using further mechanical locking devices, though keeping a contact pressure that is almost constant in spite of its thermal expansion.

Moreover, an object of the present invention is providing an anti-condensate resistance with PTC thermistor equipped with closing plugs that guarantee a greater seal with respect to known closing plugs.

Another object of the present invention is providing an anti-condensate resistance with PTC thermistor with forced ventilation through a DC-supplied fan with low cost and minimum overall sizes.

A further object of the present invention is providing an anti-condensate resistance with PTC thermistor equipped with a system for securing it onto a DIN bar with a preferred shape, made of high-temperature resistant plastic material, since the mechanical characteristics of used plastics allow embedding the elastic part into the carrier structure, allowing to realise the securing system in a single piece, thereby avoiding any structural assembling working.

A further object of the present invention is providing an assembling for manufacturing an anti-condensate resistance with PTC thermistor.

The above and other objects and advantages of the invention, as will appear from the following description, are reached by an anti-condensate resistance with PTC thermistor as disclosed in claim 1.

Moreover, the above and other objects and advantages of the invention, as will appear from the following description, are reached by a process for assembling an anti-condensate resistance with PTC thermistor as disclosed in claim 13.

Preferred embodiments and non trivial variations of the present invention are the subject matter of the dependent claims.

The present invention will be better described by some preferred embodiments thereof, provided as a non-limiting example, with reference to the enclosed drawings, in which:

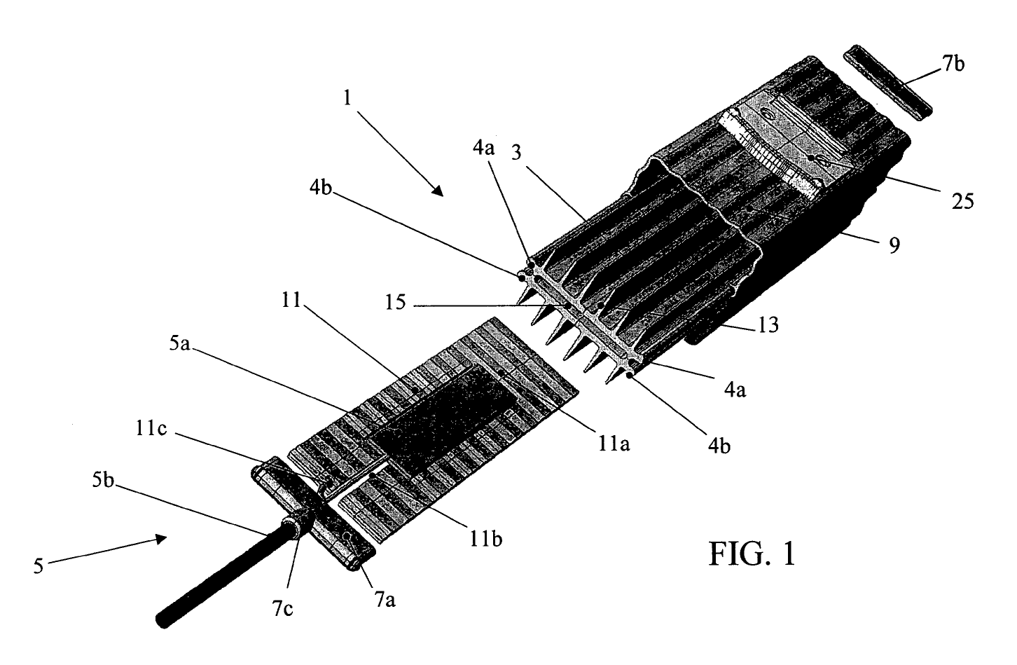

FIG. 1 shows an exploded perspective view of an embodiment of the anti-condensate resistance with PTC thermistor and related securing system according to the present invention;

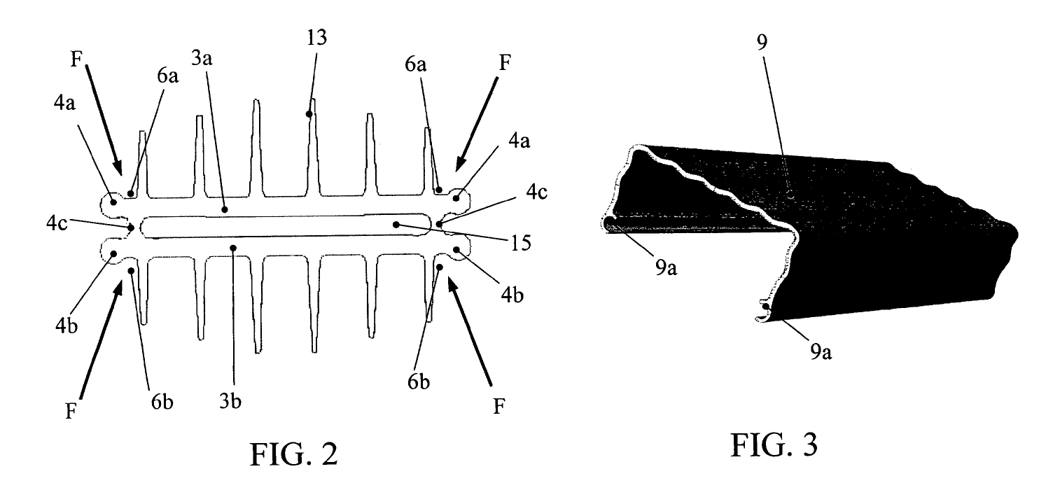

FIG. 2 shows a sectional view of an element of the anti-condensate resistance with PTC thermistor of FIG. 1;

FIG. 3 shows a perspective view of another element of the anti-condensate resistance with PTC thermistor of FIG. 1;

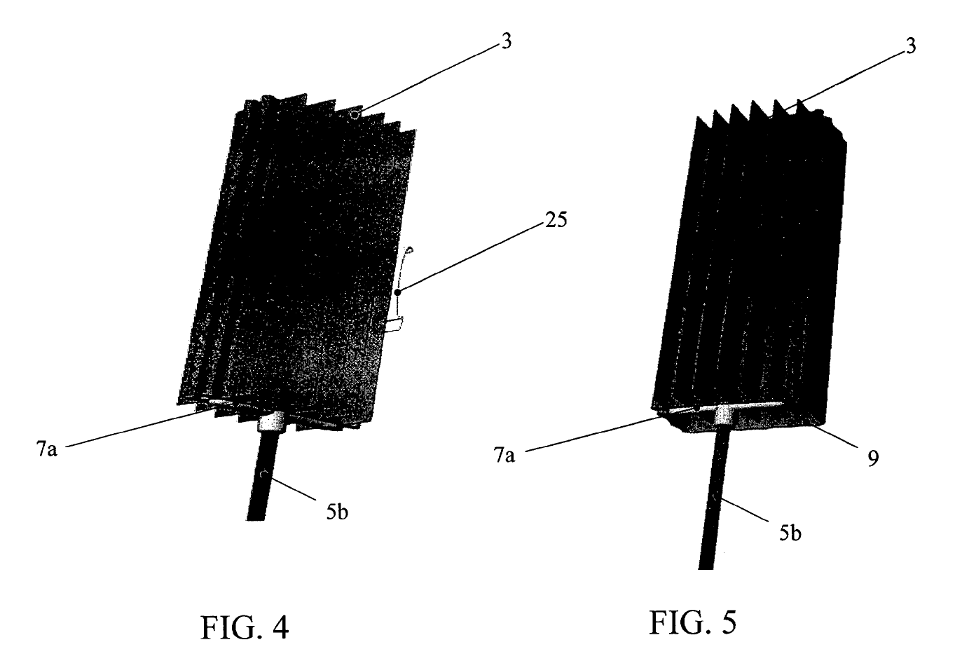

FIG. 4 shows a perspective view of a version of the anti-condensate resistance with PTC thermistor according to the present invention;

FIG. 5 shows a perspective view of another version of the anti-condensate resistance with PTC thermistor according to the present invention;

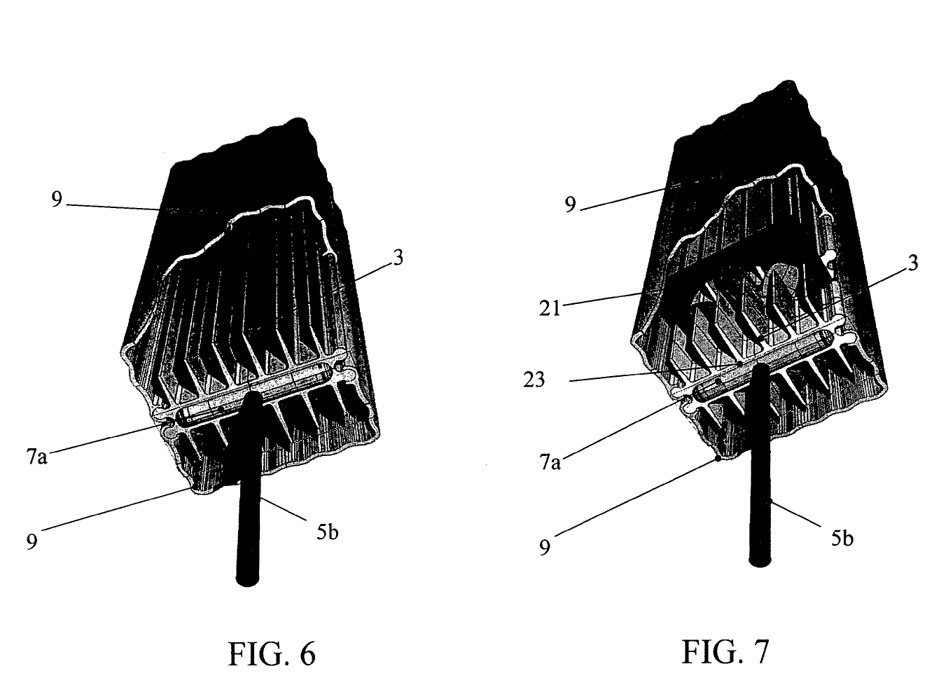

FIG. 6 shows a partially sectioned, perspective view of still another version of the anti-condensate resistance with PTC thermistor according to the present invention;

FIG. 7 shows a partially sectioned, perspective view of an anti-condensate resistance with PTC thermistor with forced ventilation according to the present invention;

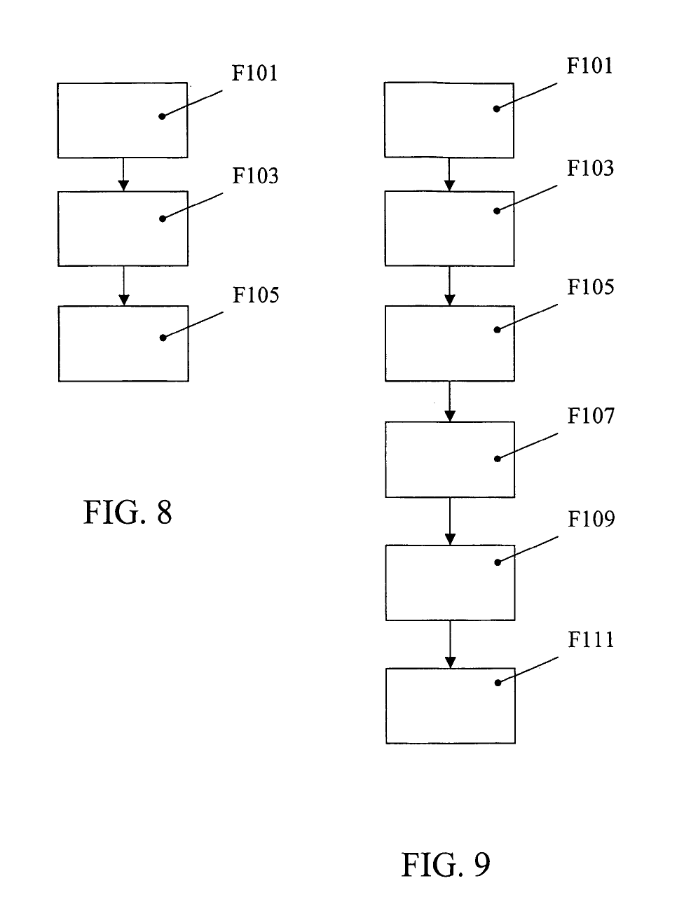

FIG. 8 shows a flow diagram showing the steps of the process for assembling an anti-condensate resistance with PTC thermistor according to the present invention; and

FIG. 9 shows a flow diagram representing the steps of the process for assembling another embodiment of the anti-condensate resistance with PTC thermistor according to the present invention.

With reference to FIG. 1, it is possible to note that the anti-condensate resistance 1 with PTC thermistor according to the present invention mainly comprises a central heat sink element 3 inside which the PTC thermistor described below is arranged, a first and a second closing plugs, respectively 7a, 7b for closing and hermetically sealing the PTC thermistor inside the central heat sink element 3; moreover, depending on the power to be dissipated, it is possible to place one or two covering profiles 9m, described below.

With reference to FIG. 2, it is possible to note a sectional view of the central heat sink element 3: such central heat sink element 3 is substantially composed of two dissipating walls 3a, 3b mutually facing and joined in such a way as to form, in a space interposed between them, a housing 15 for inserting the PTC thermistor described below, each wall equipped at its own ends with inserting tracks 4a, 4b of the covering profiles 9; such inserting tracks 4a, 4b have, in a joining portion with the respective dissipating plate 3a, 3b, some working portions 6a, 6b described below; each dissipating plate 3a, 3b is equipped on its external surface with a plurality of dissipating wings 13, preferably of a different height one to the other in order to maximise the convective sections and minimise air turbulences. Moreover, the surfaces of such wings 13 must be as smooth as possible, since possible very high grooves or roughnesses would reduce the convective effect due to reduced turbulences. It is moreover evident that the central heat sink element 3 can be anodised as black.

The PTC thermistor according to the present invention is advantageously associated with a securing element which can be realised simply and cheaply, which can be practically used and assembled that, as will be seen below, by cooperating with the central heat sink element 3, avoids using locking devices and mechanisms like in the prior art. With reference in particular to FIG. 1, it is possible to note a preferred embodiment of the PTC thermistor: in fact, it is a known PTC thermistor equipped with a known conducting or semiconducting element 5a, substantially shaped as a blade, to which a cable 5b for transporting electric current is connected; an advantageous aspect of the present invention is that such securing element, as shown in FIG. 1, is a diffusing plate 11 having in a substantially central position thereof a seat 11a inside which the element 5a is inserted and possibly a groove 11b for inserting the cable 5b; afterwards, the diffusing plate 11 coupled with the PTC thermistor is inserted into the housing 15 of the central heat sink element 3. The diffusing plate 11 performs many functions:

as previously mentioned, it keeps the PTC thermistor 5a in position;

it helps diffusing heat on the whole width of the central heat sink element 3;

through a connection 11c, for example a hole, it allows an easy grounding;

it fills in the residual space of the inserting housing 15, reducing or removing the use of additional plastic filling materials.

An advantageous and innovative aspect of the present invention is that the dissipating plates 3a, 3b are arc-shaped (with a curvature radius that can be determined by the modulus of Young of the material, by its section and by the applied compression force) in such a way that the housing 15 of the PTC thermistor is slightly narrower towards its center; the curvature of the plates 3a, 3b in fact makes them work as leaf springs; by applying, for example through crimping, some forces according to arrows F shown in FIG. 2 (at least 1 Ton×cm of length in case the central heat sink element 3 is made of aluminium) on the working portions 6a, 6b of the tracks 4a, 4b, a permanent set (about 0.6 mm) is caused to the joining hourglasses 4c of the dissipating plates 3a, 3b, this generating the cancelling or even the reversal of their curvature; such permanent set imposes a pressure (as an optimum of about 80 Kgf) of the dissipating plates 3a, 3b on the PTC thermistor and on the diffusing plate 11 or on the locking plate 5c, operatively locking them inside the central heat sink element 3, thereby advantageously removing the need of having to use further locking systems. In particular, the diffusing plate 11 can be preferably made of annealed aluminium equipped with waving: due to such waving, the diffusing plate is strongly secured in the inserting housing 15 during crimping, without interfering with the elastic force which compressed the PTC.

The closing plugs 7a, 7b, adapted to be placed on the two opposite openings of the inserting housing 15 for guaranteeing hermetic seal protecting the PTC thermistor inserted in the central heat sink element 3, can be realised, being their volume reduced, by using noble materials. In particular, the first closing plug 7a comprising a cable-pressing device 7c for passing the cable 5b can be made in a single piece. Moreover, such closing plugs 7a, 7b do not need gaskets, though guaranteeing a seal at least equal to IP65 since, after crimping, the pressure produced by the dissipating plates 3a, 3b keeps them hermetically blocked.

In particular, preferable materials for manufacturing the closing plugs 7a, 7b can be both thermoplastic and thermosetting (rubbers).

Moreover, the anti-condensate resistance 1 with PTC thermistor according to the present invention also comprises a securing system 25 of the resistance itself on a DIN bar; such securing system 25 is made of plastic material, preferably PA, such material resisting to high temperatures and allowing to make the securing system 25 in a single piece, with relevant saving in manufacturing costs.

The covering profiles 9, preferably produced through extrusion, due to their section substantially shaped as a “C”, can be completely black anodised and therefore can be much thinner than what can be found in the art, since a lot of heat arrives through radiance instead of conduction, thereby allowing an important saving of material and production resources. Moreover, the covering profiles 9 should be made with a sufficiently elastic material, in order to remove every critical aspect in the extrusion process. Each covering profile 9 is further equipped on both its longitudinal edges related to the “C” profile end with two grooves 9a adapted to be slidingly inserted in the tracks 4a, 4b of the central heat sink element 3.

As already mentioned, the anti-condensate resistance 1 according to the present invention can be configured, depending on affected powers, by using different combinations of the above-described elements for realising different heat sinks, for example by assembling none, one or two covering profiles 9 on the central heat sink element 3. Moreover, such different heat sinks can be realised for complying with different power needs, by changing the length of the central heat sink element 3, of the covering profiles 9 and/or the critical temperature of the PTC thermistor.

In particular, FIG. 4 shows, as an example, an anti-condensate resistance 1 according to the present invention for powers included in the 5-15 W range. Such anti-condensate resistance 1 is realised by using as dissipating element only the central heat sink element 3, inside which the PTC thermistor is placed, as previously described. Moreover, such central heat sink element 3 can be equipped with an external securing bracket 19 for its operating positioning. In particular, due to the particular arrangement of the dissipating wings 13 that are higher in the central position of the respective dissipating plates 3a, 3b, the anti-condensate resistance 1 in such configuration can be assembled in direct contact with electric apparata to be served, without excessively impairing the “chimney effect”.

With reference to FIG. 5, it is possible to note, as an example, an anti-condensate resistance 1 according to the present invention for powers included in the 20-30 W range. Such anti-condensate resistance 1 is realised b using as dissipating element the central heat sink element 3, inside which the PTC thermistor is placed, as described previously, on which a single covering profile 9 is inserted. Such anti-condensate resistance 1 arrangement mainly operates due to the chimney effect on the side of the central heat sink element 3 equipped with the covering profile 9, while it mainly operates by radiance on the opposite side.

With reference to FIG. 6, it is possible to note, as an example, an anti-condensate resistance 1 according to the present invention for powers included in the 35-70 W range. Such anti-condensate resistance 1, as previously seen, is realised by using as dissipating element the central heat sink element 3, inside which the PTC thermistor is placed, as described previously, on which two covering profiles 9 are inserted. Such anti-condensate resistance 1 arrangement is preferably characterised by a mediocre thermal cutting towards the outside, in such a way as to be able to rise the central heat sink element 3 temperature without dangers.

FIG. 7 shows in particular an embodiment of the anti-condensate resistance 1 according to the present invention for powers included in the 75-150 W range, equipped with an electric fan 21 for forced cooling ventilation. Such electric fan 21 is supplied with direct current and therefore it is advantageously of low cost and reduced encumbrance; the front block 23 contains the electronics for supplying and/or driving the electric fan; such electric fan 21 is preferably arranged in order to generate an air flow which is parallel to the dissipating wings 13 passing between the central heat sink element and the covering profiles 9.

FIG. 8 schematically shows the process for assembling an anti-condensate resistance 1 according to the present invention; in particular, such process, obviously after the manufacturing of the individual components with the most suitable modes, comprises the steps of:

inserting (F101) the PTC thermistor into the inserting housing 15 of the central heat sink element 3;

inserting (F103) the closing plugs 7a, 7b into the openings of the inserting housing 15; and

through a crimping press, exerting (F105) some forces F on the working portions 6a, 6b for permanently setting the dissipating plates 3a, 3b in such a way as to cancel or reverse their curvature and blocking the PTC thermistor inside the inserting housing 15 and the closing plugs 7a, 7b in the openings of the inserting housing 15.

The process according to the present invention provides, as shown in FIG. 9 and depending on the configuration of the heat sinks to be manufactured, also the following additional steps:

through a crimping press, performing (F107) a projection-punching on at least two tracks 4a, 4b related to the same dissipating plate 3a, 3b;

placing (F109) at least one covering profile 9 on the central heat sink element 3 by inserting each track 4a, 4b into a respective groove 9a till it abuts against the punched projection;

pressing (F111) through a press the covering profiles 9 placed on the central heat sink element 3 and sliding the grooves 9a on the respective tracks 4a, 4b till the punched projection is passed, thereby blocking them on the central heat sink element 3 itself.

1. Anti-condensate resistance (1) with PTC thermistor, characterised in that it comprises a central heat sink element (3), said central heat sink element (3) being composed of two dissipating plates (3a, 3b) which are mutually facing and continuously joined in such a way as to form, in a space interposed between said plates, an inserting housing (15) of said PTC thermistor together with a securing element (11), a first and a second closing plugs (7a, 7b) for closing openings of said inserting housing (15) and for hermetically sealing said PTC thermistor inside said inserting housing (15); said dissipating plates (3a, 3b) being equipped with a convex curvature towards their center, each one of said dissipating plates (3a, 3b) being equipped at their ends with inserting tracks (4a, 4b) forming working portions (6a, 6b) on which forces (F) are exerted which are adapted to permanently set joining hourglasses (4c) of said dissipating plates (3a, 3b) so that said dissipating plates (3a, 3b) can elastically press onto said PTC thermistor, at the same time cancelling the curvature of said dissipating plates (3a, 3b) in order to maximise a contact surface between said dissipating plates (3a, 3b) and said PTC thermistor in said inserting housing (15) and to block said closing plugs (7a, 7b) in said openings; each one of said dissipating plates (3a, 3b) being equipped on an external surface with a plurality of dissipating wings (13).

2. Anti-condensate resistance (1) with PTC thermistor according to claim 1, characterised in that it comprises at least one securing system (25), said securing system (25) being made of plastic material, preferably PA, in a single piece.

3. Anti-condensate resistance (1) with PTC thermistor according to claim 1, characterised in that said central heat sink element (3) is anodised in black or another colour.

4. Anti-condensate resistance (1) with PTC thermistor according to claim 1, characterised in that said dissipating wings (13) have different heights.

5. Anti-condensate resistance (1) with PTC thermistor according to claim 1, characterised in that said securing element is a diffusing plate (11) having, in a substantially central position thereof, a seat (11a) for housing a conductive or semiconductive element (5a) of said PTC thermistor.

6. Anti-condensate resistance (1) with PTC thermistor according to claim 5, characterised in that said diffusing plate (11) is equipped with a grounding connection (11c).

7. Anti-condensate resistance (1) with PTC thermistor according to claim 5, characterised in that said diffusing plate (11) is equipped with an inserting groove (11b) of an electric connection cable (5b) of said PTC thermistor.

8. Anti-condensate resistance (1) with PTC thermistor according to claim 5, characterised in that said diffusing plate (11) is made of waved annealed aluminium.

9. Anti-condensate resistance (1) with PTC thermistor according to claim 1, characterised in that it comprises at least one covering profile (9) whose section is substantially “C”-shaped, said covering profile (9) being equipped on both its longitudinal edges with a respective groove (9a) adapted to be slidingly inserted into a respective cylinder (4a, 4b).

10. Anti-condensate resistance (1) with PTC thermistor according to claim 9, characterised in that said covering profile (9) is completely anodised in black or another colour.

11. Anti-condensate resistance (1) with PTC thermistor according to claim 1, characterised in that it comprises an electric fan (21) supplied with direct current and an electronic for supplying and/or driving said electric fan (21) integrated in a front block (23).

12. Anti-condensate resistance (1) with PTC thermistor according to claim 1, characterised in that said closing plugs are made of thermoplastic or thermosetting material.

13. Process for assembling an anti-condensate resistance (1) with PTC thermistor according to claim 1, characterised in that it comprises the steps of:
inserting (F101) said PTC thermistor into said inserting housing (15) of said central heat sink element (3) with said securing element (11);
inserting (F103) said closing plugs (7a, 7b) into said respective openings of said inserting housing (15); and
through a crimping press, exerting (F105) forces (F) on said working portions (6a, 6b) for permanently setting said dissipating plates (3a, 3b), said permanent set being adapted to cancel or reverse said curvature and to block said PTC thermistor inside said inserting housing (15) and said closing plugs (7a, 7b) in said respective openings of said inserting housing (15).

14. Assembling process according to claim 13, characterised in that it comprises the additional steps of:
through a crimping press, performing (F107) a projection-punching on at least one of said tracks (4a, 4b) related to a same dissipating plate (3a, 3b);
placing (F109) at least one of said covering profiles (9) on said central heat sink element (3) inserting each track (4a, 4b) in a respective groove (9a) till it abuts against said punched projection; and
pressing (F111) through a press said at least one covering profile (9) placed on said central heat sink element (3) and sliding said grooves (9a) on said respective tracks (4a, 4b) till said punched projection is passed.
